(19) United States
(12) Patent Application Publication
(10) Pub. No.: US 2009/0313253 A1
(43) Pub. Date: Dec. 17, 2009

(54) BUSINESS METHOD FOR COMMUNICATION ENGINE

(76) Inventors: Rafael Castillo, Miami, FL (US); Ben Davenport, Fort Lauderdale, FL (US); Ryan Nolan, Coral Springs, FL (US)

Correspondence Address: Rafael Castillo, 15251 S.W. 11th Street, Miami, FL, 33194, US

(21) Appl. No.: 12/140,337

(22) Filed: Jun. 17, 2008

(51) Int. Cl. G06F 17/30

(52) U.S. Cl. 707/9; 707/E17.005

(57) ABSTRACT

A method for coordinating the way two subscribing members communicate with the objective of enhancing their relationship, or detect incompatibilities at an early stage that will permit any one of them to opt out. The five phases of the method are: the seed request phase, the seedling phase, the budding phase, the juvenile phase, and the maturation or fruition phase.

### BACKGROUND OF THE INVENTION

1. Field of the Invention

The present invention relates to a method for organizing, restricting and coordinating the communication between two individuals with the objective of enhancing the probabilities of matching their individual affinity characteristics.

2. Description of the Related Art

Several systems for matching subscribers have been designed in the past. None of them, however, includes the novel features claimed herein, including permitting subscribers to advance through a predetermined number of phases with different levels of communication privileges.

Applicant believes that the closest reference corresponds to WIPO publication No. 03/071449, published on Aug. 28, 2003, for a method and system to connect and match users in an electronic dating service. However, it differs from the present invention because there are no time limits and initially there are no real time communications. Also, the particulars of a subscriber as well as other information and communication privileges are released in a calibrated fashion as the subscribers advance through the phases in the present invention.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a method for organizing, restricting and coordinating the communication between two individuals with the objective of enhancing the probabilities of matching their individual affinity characteristics.

It is still another object of the present invention to provide such a method that can progressively contribute to the growth of the relationship between two subscribing members.

Another object of the present invention is to provide a balance on the decision to accept the requests, responses and replies, as well as the calibrated liberation of the subscribing members' information in a database in response to their actions.

It is yet another object of this invention to provide such a method that can be readily implemented and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a flowchart of the phases comprised in the method subject of the present application.

FIG. 2 shows the first phase of the method which is referred to as the seed request phase in FIG. 1.

FIG. 3 illustrates the second phase of the method which is referred to as the seedling phase in FIG. 1.

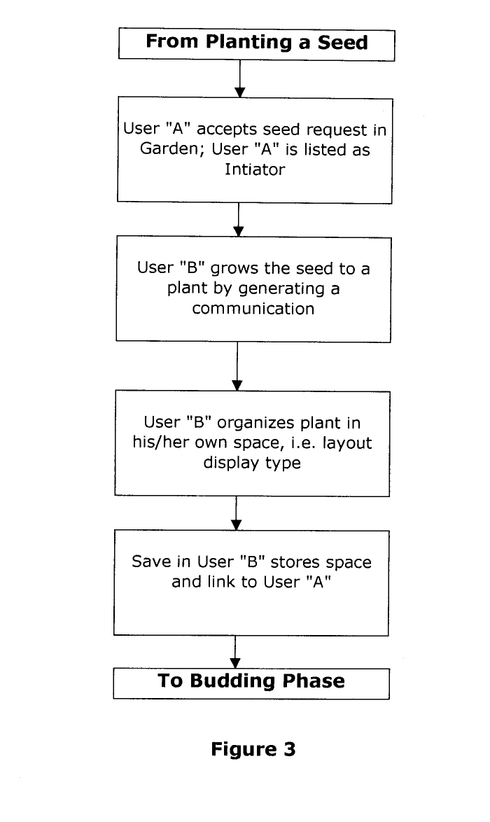

FIG. 4 is a representation of the third phase of the method which is referred to as the budding phase in FIG. 1.

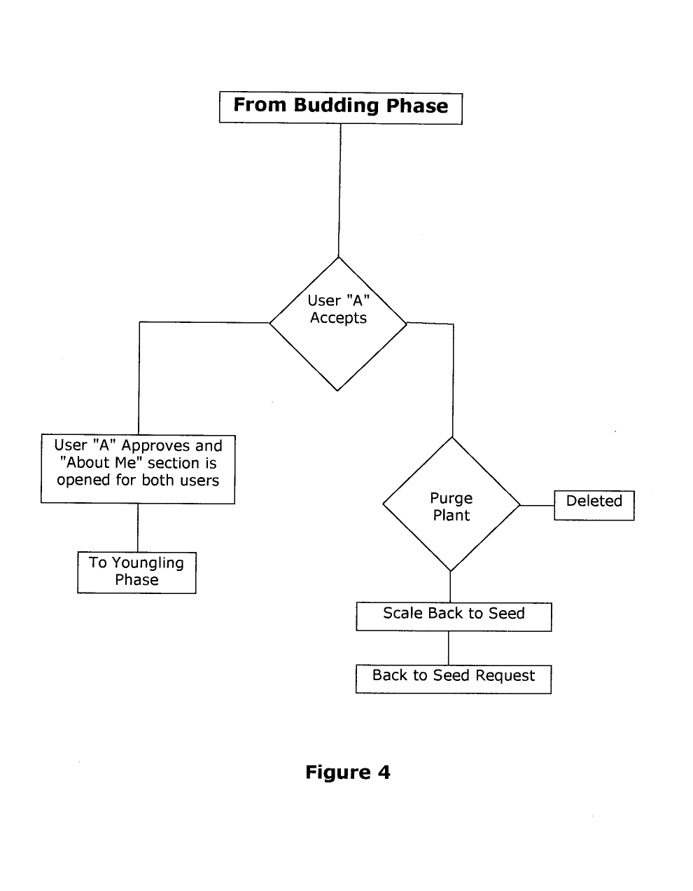

FIG. 5 is a representation of the fourth phase of the method which is referred to as the youngling phase in FIG. 1.

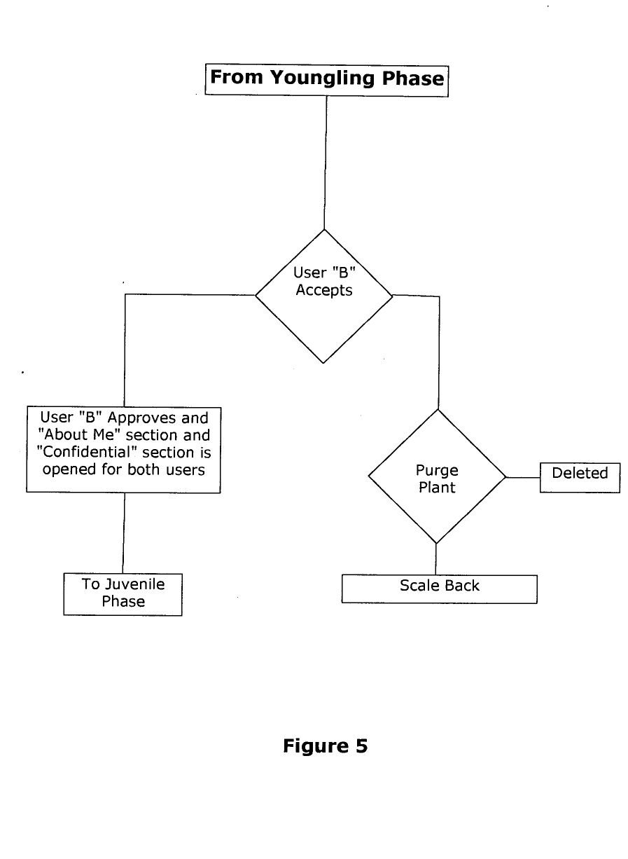

FIG. 6 represents the fifth phase of the method which is referred to as the juvenile phase in FIG. 1.

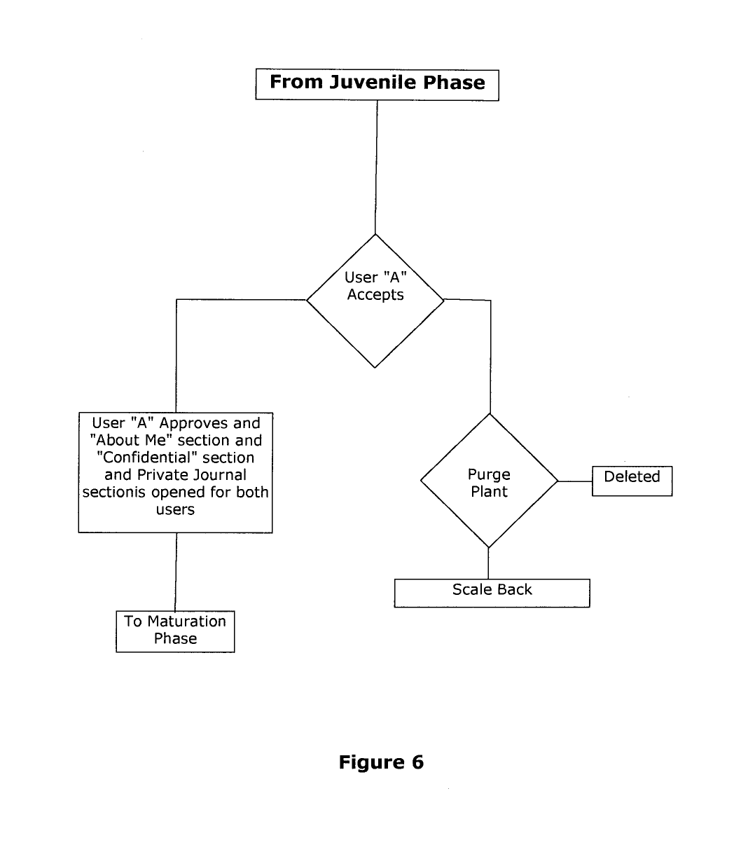

FIG. 7 represents the sixth and last phase of the method which is referred to as the maturation or fruition phase in FIG. 1.

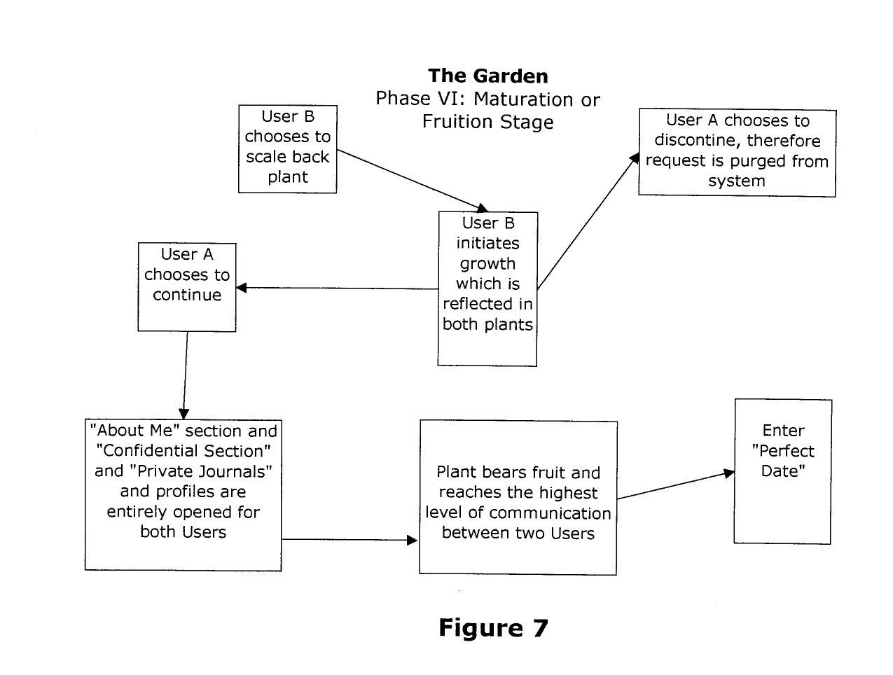

### DETAILED DESCRIPTION OF THE PREFERRED EMBODIMENT

Referring now to the drawings, where the present invention is generally referred to with numeral 10, it can be observed that it basically includes a method for coordinating the way two subscribing members communicate with the objective of enhancing their relationship, or detect incompatibilities at an early stage that will permit any one of them to opt out. As the relationship progresses, the seed planted is cultivated, taken care of, and grown by the actions of the members. A calibrated release of information to the two members is used to enhance their interest in pursuing the relationship. While a metaphoric reference is made in the body of this section of the application, as the inventor's best manner of expressing his invention, this denomination is not to be taken in a limiting sense as other metaphors can also be used. The important steps of alternating the power to exit from the relationship and/or approve the release of information to a higher level is more important than how it is described.

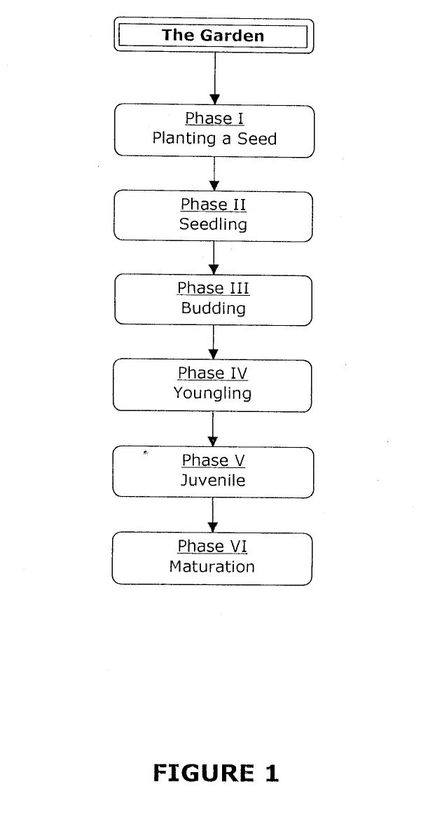

In FIG. 1, the six phases of one of the preferred embodiments for the method are represented, namely, the seed request phase, the seedling phase, the budding phase, the youngling phase, the juvenile phase, and the maturation or fruition phase.

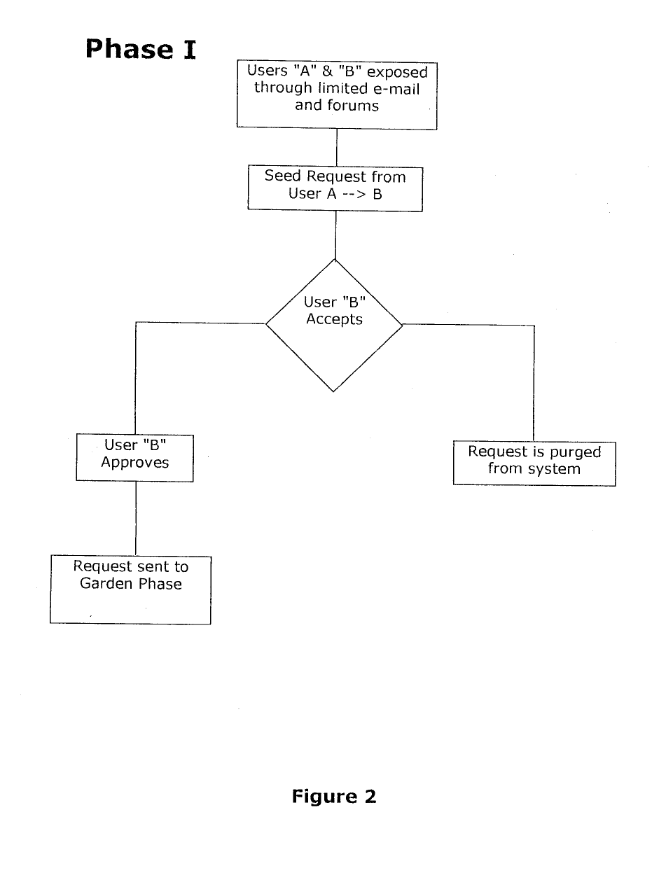

Starting with the seed request phase, represented in FIG. 2, we can see that subscribing members are those participating in the method whereas by user the Applicant refers to the operator of the method. A predetermined amount of information for each member is entered in a database. A portion of this information for each member is made available to all subscribing members so they can interact with each other based on this limited amount of information. For example, a name (not necessarily the subscribing member's real name), sex, age, and email (or similar communication means) could be the initial portion of information that can be made available to the members.

In the first phase of the method, the seed request phase, one of the subscribing members, member A, with access to a networked database initiates a request for communicating with another subscribing member, member B. The request is transmitted to member B and it is incorporated in an initial log set up for this particular relationship between these two members. This log keeps track of the date the request was sent, receipt acknowledged, etc. A user can program the method to include reminders to be sent to either member, or both, about their deadlines for responding, alerting them as to the time that has elapsed, etc. Member B then has the option of rejecting the request and removing it from the log, or accepting it for subsequent consideration for approval.

In the second phase, seedling, the relationship is enhanced if member B decides to approve the request. Automatically, another portion of the information held in the database is released to both of the subscribing members. Member B now has to take the initiative of formulating a response to the request. The user can require, under one of the preferred embodiments, for the response to be transmitted within a certain period of time, or else a rejection will be assumed. Or other variations.

For the third phase, budding, the response sent to member A is either rejected or accepted. If rejected, the request and the response from member B will be deleted and the relationship eliminated. If approved, member A is given certain amount of time to formulate a reply which will, again, release another portion of the information in the database to the participating members in this relationship.

In the fourth phase, the youngling phase, the reply transmitted to member B is either rejected or accepted. If rejected, the request, response, and reply are deleted and the relationship terminated, or sent (scaled) back to the more limited access to a user's information. While some of the information is not changed and has already been delivered, other pieces of information can change (employment, interests, free schedule, etc.) that can be masked out again, if there is a recession (scaled back) to a previous level. A user for a system can optionally provide hints or tips to those members receiving a regressive action.

In the fifth phase, the juvenile phase, the reply transmitted to member A is either rejected or accepted. If rejected, the request, response, and reply are deleted and the relationship terminated, or sent (scaled) back to the more limited access to a user's information. While some of the information is not changed and has already been delivered, other pieces of information can change (employment, interests, free schedule, etc.) that can be masked out again, if there is a recession to a more basic level. If member A accepts the plant grown by member B, then more information from the profile is released. A user for a system can optionally provide hints or tips to those members receiving a regressive action.

In the sixth phase, the maturation or fruition phase, the reply transmitted to member B is either rejected or accepted. If rejected, the request, response, and reply are deleted and the relationship terminated, or sent (scaled) back to the more limited access to a user's information. While some of the information is not changed and has already been delivered, other pieces of information can change (employment, interests, free schedule, etc.) that can be masked out again, if there is a recession to a more basic level. If member B accepts the plant grown by member A, then members are directed to the “Perfect Date” mini-game.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A method for coordinating the way two subscribing members communicate, comprising the steps of:
A) initiating a request by a first subscribing member for a communication with a second subscribing member from a plurality of subscribing members having access to a database with a first predetermined amount of information for each of said subscribing members made available to said subscribing members, said first subscribing member causing said request to be sent to said second subscribing member and incorporating said request in a first log, said second subscribing member then causing said request to be rejected and removed from said first log or accepting said request and entering it in a second log;
B) upon approval by said second subscribing user of said request included in said second log, a second predetermined amount of information from said database is made available to said first and second subscribing users, and said second user causes a first response to said request to be sent to said first user;
C) upon receipt by said first subscribing user of said first response, said first subscribing user causes said first response to be rejected and said first response removed from said second log or accept said first response and entering it in a third log;
D) upon approval by said first subscribing user of said first response included in said third log, a third predetermined amount of information from said database is made available to said first and second subscribing users, and said first user causes a first reply to said first response to be sent to said second subscribing user;
E) upon receipt by said second subscribing user of said first reply, said second subscribing user causes said first reply to be rejected and said first response removed from said third log or accept said first reply and entering it in a fourth log; and
F) upon approval by said second subscribing user of said fist reply included in said fourth log, a fourth predetermined amount of information from said database is made available to said first and second subscribing users so that further action can be undertaken by said first and second subscribing members to enhance their relationship.

2. A method for coordinating the way two subscribing members communicate, comprising the steps of:
A) initiating a request by a first subscribing member for a communication with a second subscribing member from a plurality of subscribing members having access to a database with a first predetermined amount of information for each of said subscribing members made available to said subscribing members, said first subscribing member causing said request to be sent to said second subscribing member and incorporating said request in a first log, said second subscribing member then causing said request to be rejected and removed from said first log or accepting said request and entering it in a second log;
B) upon approval by said second subscribing user of said request included in said second log, a second predetermined amount of information from said database is made available to said first and second subscribing users, and said second user causes a first response to said request to be sent to said first user;
C) upon receipt by said first subscribing user of said first response, said first subscribing user causes said first response to be rejected and said first response removed from said second log or accept said first response and entering it in a third log;
D) upon approval by said first subscribing user of said first response included in said third log, a third predetermined amount of information from said database is made available to said first and second subscribing users, and said first user causes a first reply to said first response to be sent to said second subscribing user;
E) upon receipt by said second subscribing user of said first reply, said second subscribing user causes said first reply to be rejected and said first response removed from said third log or accept said first reply and entering it in a fourth log; and
F) upon approval by said second subscribing user of said fist reply included in said fourth log, a fourth predetermined amount of information from said database is made available to said first and second subscribing users so that further action can be undertaken by said first and second subscribing members to enhance their relationship.
G) upon receipt of advancement request, members A or B can choose to scale back or purge requests from system.
